(19) United States
(12) Patent Application Publication
(10) Pub. No.: US 2010/0127181 A1
(43) Pub. Date: May 27, 2010

(54) Radiation sensor arrays for use with brachytherapy

(76) Inventors: Paul A. Lovoi, Saratoga, CA (US); Steve Axelrod, Los Altos, CA (US)

Correspondence Address: THOMAS M. FREIBURGER, P.O. BOX 1026, TIBURON, CA, 94920, US

(21) Appl. No.: 12/321,593

(22) Filed: Jan. 21, 2009

Related U.S. Application Data
(63) Continuation-in-part of application No. 11/323,331, filed on Dec. 30, 2005.
Application No. 11/323,331 is a continuation-in-part of application No. 11/233,921, filed on Sep. 22, 2005, now abandoned.
(60) Provisional application No. 61/011,562, filed on Jan. 18, 2008.

(51) Int. Cl. G01T 1/02

(52) U.S. Cl. 250/370.07

(57) ABSTRACT

A radiation sensor array is carried on a flexible sheet of film, for placement on the skin of a patient adjacent to a brachytherapy location beneath the skin. With the array approximately centered on a position where radiation source to skin distance is estimated to be minimum, the array of sensors is used to monitor radiation dose received at the skin. With a controller connected to the array and preferably also to the radiation source in the applicator, the radiation dose received at all skin points of interest can be monitored, a point of maximum dose and a projected approach to limit dose can be calculated, and in response the system can warn the operator or control a brachytherapy procedure so as to discontinue radiation or control the radiation level or source position in real time. The system can also include percutaneous sensors.

This application is a continuation-in-part of application Ser. No. 11/323,331, filed Dec. 30, 2005, which was a continuation-in-part of application Ser. No. 11/233,921, filed Sep. 22, 2005 (now abandoned). Those applications are fully incorporated herein by reference. This application also claims benefit from provisional application Ser. No. 61/011,562, filed Jan. 18, 2008.

### BACKGROUND OF THE INVENTION

This invention concerns radiation therapy, especially brachytherapy, for treating tissues which may have diffuse proliferative disease. Brachytherapy involves placing a radiation source within a surgically created or naturally occurring cavity (the treatment cavity) in the body, often as adjuvant therapy following tumor resection. In particular the invention concerns sensing of radiation dose in a treatment planning step or in real time during therapy, to control the result of the therapy.

The present invention is described below in terms relating to radiation therapy applied to the human breast following surgical treatment of cancer, but its principles can be extended to similar applications in other tissues. When it is desired that brachytherapy follow surgical resection, a therapeutic radiation dose is prescribed to be administered to a volume of tissue (the target tissue) lying just outside the treatment cavity, into which at least one radiation source is placed and perhaps manipulated. Generally the prescription will specify (at least) a uniform dose to be delivered at a preferred depth outside the treatment cavity (the prescription depth). The radiation is usually delivered in fractions, the sum of which comprise the total dose prescribed.

From a medical standpoint, it is important to avoid overdose at the first tissue surface to be treated (generally the cavity surface), or at any other tissue structure which might be adversely affected by the therapy. Since radiation intensity decays rapidly with increasing distance from the radiation source, it is clear that the dose at the cavity surface will always be higher than the prescribed dose at prescription depth. In order to moderate dose at the cavity surface and avoid overdose, it is customary to create and maintain distance between the source and the cavity surface. An applicator, often comprising an inflatable balloon, is frequently used for the purpose. Upon inflation, the balloon both fills and shapes the resection cavity, usually into a predetermined figure of revolution (e.g., a sphere or ellipsoid). Preferably the balloon is inflated using a liquid medium like water or saline which attenuates dose intensity in addition to the reduction resulting from distance.

Generally, the applicator further comprises a tubular source guide situated within the cavity which locates the source and through which the source may be traversed. In order to deliver the prescribed dose at a fixed depth outside the cavity, the source is usually moved through a series of positions sequentially, with dwell times in each position to create an isodose pattern concentric with the balloon and cavity. Multiple source guides and sources may be employed similarly. Further discussion of the use of brachytherapy applicators can be found in U.S. Pat. No. 6,413,204.

Often, skin, bone or other radiation sensitive anatomic structures will be found to lie within the range of the target tissue. In such a circumstance, the otherwise uniform prescription dose may need to be moderated to avoid a radiation overdose. Current standards require that skin not receive a dose of more than about 1.5 times the prescription dose. With a one centimeter prescription depth, this usually requires the skin be at least 6-8 mm away from the surface of an applicator engaged against the tissue in the cavity, for a typically sized applicator balloon and cavity. A distance of less than about 6-8 mm may result in doses higher than 1.5 times the prescription dose which is known often to result in undesirable cosmesis. These skin proximity problems commonly arise in treating the breast, and unless measures can be taken to protect the skin or other at-risk anatomy, brachytherapy may be contra-indicated. In brachytherapy applications generally, prescription depths other than one centimeter may be preferred, but the proximity and overdose concerns described above still apply, both for skin and for other at-risk structures.

An initial step in brachytherapy treatment planning is to assess the cavity shape established by the applicator and the distance from the cavity surface to skin surfaces or to any other radiation sensitive tissues likely to be affected by the radiotherapy. Imaging of the cavity and applicator is usually carried out with conventional x-ray or CT scanning apparatus, and will generally reveal regions of skin (or other structures) which may lie within or be near enough to the target tissue to be of concern. The location of maximum dose delivered to and absorbed by such skin will generally be near, but not necessarily at the location where the distance from the skin to the cavity is minimum, potentially lending a degree of error to estimations of likely maximum skin dose. Also, correlating a location on an imaging film record to a precise location on the patient's physical anatomy can be difficult. In principle, radio-opaque markers or sensors may be placed on the skin where the tissue is thinnest, perhaps with the help of palpation to assist in finding the thinnest tissue location. However, as noted above, that location will not necessarily be the point of maximum absorbed dose. Any such error will result in a lower reading than the true maximum dose indication, and thus may become a factor in deciding whether brachytherapy can be prescribed for a particular patient. Such decision making is of necessity conservative, and when viewed in this manner, any uncertain potential for overdose tends to exclude brachytherapy as an appropriate treatment modality for the patient.

Because of the recognized advantages of brachytherapy, notably less radiation passing through normal tissue than is the case with external beam methods, there is clearly a need for improvements which result in more accurate assessment of maximum dose absorbed during treatment, and in feedback which is sufficiently timely to prevent overdose. Furthermore, for the patient population as a whole, more accurate absorbed dose data could be used to correlate dose with cosmetic observations, and potentially could collectively lead to setting higher skin dose limits before adverse cosmesis would be expected.

These and other objects of the invention will be apparent from the drawings and further description which follows.

### SUMMARY OF THE INVENTION

If imaging of the applicator apparatus and adjacent anatomy preparatory to brachytherapy reveals tissue structure deemed to be at risk of overdose, this invention provides placing a sensor array adjacent to the structure to sense any overdose and to so warn the therapist in a timely manner. Such an array may comprise solid-state sensors positioned on a backing material and fastened on the skin.

If to be positioned on the patient's skin according to the invention, the array can be of a predetermined shape, such as a square pattern of four sensors with a fifth sensor in the middle. Further, the array is large enough such that when placed on the skin according to imaging records or palpation clues, the array will easily cover the point of closest distance between skin and cavity and hence be near the likely point of maximum dose as well. The sensor array is connected so as to communicate with the central controller managing the therapy such that absorbed dose feedback from the array is included in the treatment record and may be processed as desired. Such connections may be conventional or wireless.

If desired, the array can alternatively be placed on the skin prior to imaging. Then, if the sensors also comprise radio-opaque (or partially radio-opaque) markers, their positioning on the imaging record may be more easily correlated with their position on the patient's skin. If the imaging record then reveals the sensor placement to be less than optimal, the position of the array can be adjusted accordingly, and if necessary, imaging repeated.

An array may also comprise a multiplicity of sensors placed percutaneously adjacent an at-risk internal tissue structure. Radiation sensors mounted at the tips of metallic needles for percutaneous placement will exhibit radio-opacity. This will allow placement under fluoroscopic or similar guidance. The percutaneous placement of individual sensors may result in an array which is not of a regular or predictable shape, but the imaging record can be used to determine the sensor positions relative to one another and in relation to the anatomy, and a film can be preserved with such information. Such percutaneous sensor placement is well known to those of skill in the art.

Once an array is properly positioned, conventional treatment planning can proceed, establishing treatment parameters, followed by the treatment. As treatment proceeds, the sensor array is interrogated frequently and feedback is gathered which is then collected and/or processed by the central controller. Using least squares or another appropriate algorithm to model absorbed dose within the bounds of the array, the point of maximum dose can be predicted and the sensor outputs used to monitor and/or predict delivered dose as therapy proceeds, or even to anticipate when an overdose is likely. If such modeling reveals that a proper therapeutic dose cannot be delivered as prescribed without overdosing normal tissue structures, the therapist can be warned appropriately. If necessary, brachytherapy can be abandoned.

The apparatus and methods of this invention can be combined with those of co-pending U.S. patent applications Ser. Nos. 10/464,160, 11/394,640 and 11/932,974, all incorporated herein in their entirety by reference. These applications disclose cavity mapping and use of directional x-ray sources which can be switched on and off or modulated as to output. These referenced methods and apparatus can be used with the sensor outputs described herein to limit dosage to at-risk structures while delivering a therapeutic dose to target tissues. Such control can be based on the frequent interrogation described above, during the planning phase of the brachytherapy, or can be used in real-time where continuous control is applied, even during a single treatment fraction.

For applying intermittent adjustments to the treatment, MOSFET sensors (Best Medical International, Inc./Thomson Neilsen, 25-B Northside Road, Nepean, Ontario, Canada) are preferred. They can be interrogated as frequently as every ten seconds, sufficient frequency to indicate whether cumulative dose is approaching any limit of concern. If real time control is desired, sensors similar to Profiler 2 sensors (Sun Nuclear Corporation, Melbourne, Fla.) may be used. Such sensors will permit real-time feedback control of radiation emissions during treatment. Either type of sensor can be used as a fail safe device. If a limit dose is anticipated or reached, treatment can be terminated, either automatically acting through the treatment controller, or by manual intervention in response to a sensor warning.

Finally, sensor output can provide monitoring and verification of treatment as delivered, as well as providing basis for a permanent record of treatment in the patient's medical file.

It should be noted that other numbers of sensors (than five) and other array patterns (than square) may be employed without departing from the invention herein disclosed. Also and again as described above, although the principle of arraying sensors is described above in terms of protecting against skin overexposure, it is clear that an array of solid state sensors can be positioned percutaneously around other tissue structures within the body so they can be protected in a similar manner. Bones and organs are examples of such structures perhaps requiring local protection from overdose.

From the preceding discussion, it is apparent that such sensor arrays can facilitate intermittent or real-time control of emitted radiation, monitoring for patient safety purposes, or to verify dose actually delivered during treatment.

### DESCRIPTION OF THE DRAWINGS

FIG. 1 is a depiction in perspective view of a five sensor embodiment of the invention, and showing a controller connected to the sensors.

FIG. 2 is a cross-section view through a balloon applicator within resection cavity in tissue with a sensor array placed on the skin and also an example of a sensor placed percutaneously near a section of bone.

FIG. 3 is a perspective view in broken section showing the array of FIG. 1 positioned on a breast, with a balloon applicator in a resection cavity of the breast as shown in FIG. 2.

### DESCRIPTION OF PREFERRED EMBODIMENTS

Solid state radiation sensors, including MOSFET sensors, are well known for their ability to measure absorbed doses of radiation. In essence, they are solid-state devices which degrade in response to cumulative exposure to radiation. They are generally connected by wires to instruments which can impose a current across a semi-conductor junction within the sensor, and read the voltage developed across the junction. Depending on the amount of radiation absorbed by the sensor, the voltage changes. Therefore, after a calibration step to establish an initial voltage reading followed by exposure to radiation, the voltage is again read. The change in readings can be correlated to the amount of radiation absorbed between readings. The life of the sensor is limited in that, once exposed to its limit exposure, it cannot be rejuvenated and must be discarded. Within the exposure ranges commonly used in radiotherapy, however, MOSFET sensors and other solid state sensors have great utility. Further MOSFET and other solid state sensor information can be obtained from the references noted above.

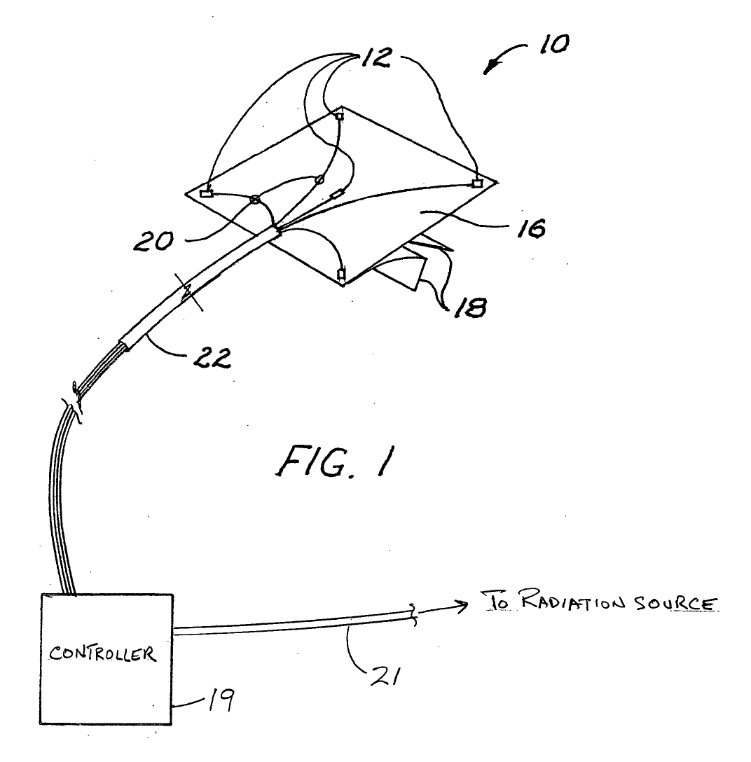

FIG. 1 shows a square array 10 of MOSFET sensors 12, with a fifth MOSFET 12 in the center of the square. Other patterns can be used if desired. The array is mounted on a sheet of fabric or polymeric film 16. Polyurethane film and flexible printed-circuit film like DuPont Kapton are suitable materials (the sensors could also be in or on a flexible radiation shield as in copending application Ser. No. 11/323,331 referenced above). The sensors 12 can be secured to the fabric or film by use of conventional adhesives, for example.

The underside of the fabric or film 16 (the side intended to face the skin) can have a pressure-sensitive adhesive layer protected by release paper or strips 18, and applied much like a BAND AID, which will make placing the array a simple matter for the therapist. Alternatively, the fabric or film can be without adhesive, and conventional adhesive tape used to overlie the film and hold it in position on the skin. The sensors 12 are connected to a central controller 19 by wires 20, although a wireless connection could be included. The wires are bundled into a cable 22 leading to the central controller, which is also indicated at 21 as preferably connected as well to a radiation source in a brachytherapy applicator. Preferably, for imaging as described above, the positions of the sensors 12 are rendered partially radio-opaque. Radio-opacity is, for example, provided by placing radio-opaque material (e.g. including tungsten powder) on the outer sides of the sensors 12 if they are on the upper side of the film 16. If the sensors are on the inner, skin-facing side, the radio-opacity can be provided by loading the adhesive securing the sensors to the fabric or fiber 16. Other fillers providing radio-opacity and other fastening means are well known to those of skill in the art.

The film and array are large enough dimensionally to make it easy for the therapist to position the array such that it overlies the thinnest portion of tissue adjacent the resection cavity. When a radio-opaque array is placed before imaging preparatory to treatment planning, imaging will reveal the thinnest tissue section overlying the resection cavity and its relationship to the array. When the array positioning properly covers the region of thinnest tissue, sensor output and/or processing (with interpolation/extrapolation) will indicate the maximum dose absorbed at the skin and the position of the maximum. For example, in the case of the “cross” geometry of five sensors, one can perform parabolic fits to the three dose values along both of the orthogonal axes formed by the cross. From the centroids of the fits, the highest dose position can be inferred, and the dose at that point estimated. Programming in the controller can find any maximum point on the sheet 16, regardless of location, by interpolation.

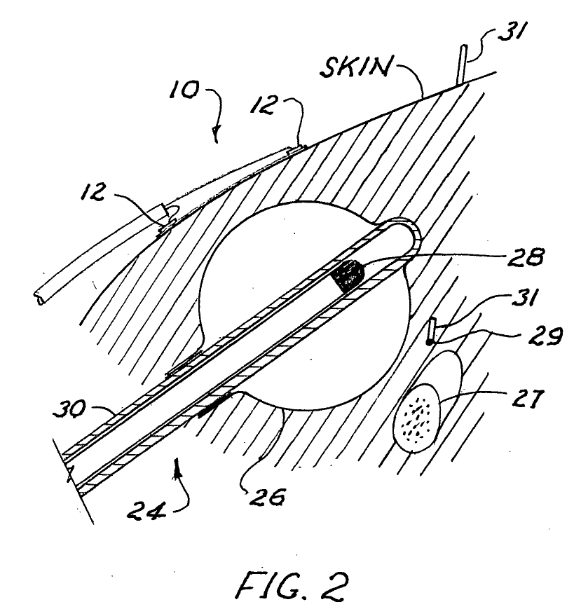

FIG. 2 shows the patient's skin and a portion of breast anatomy in cross section, with a balloon applicator 24 positioned in a resection cavity 26. Adjacent to the resection cavity, the array 10 of sensors 12 is positioned where the skin-to-cavity tissue is thinnest. A source 28 is shown positioned within a source guide 30 of the applicator 24.

FIG. 2 also shows a section of bone 27 adjacent to the resection cavity 26, and a sensor 29 (one sensor member of a percutaneous array) on the end of a needle 31. The percutaneous array so placed can be used to assure overdose to the bone 27 is avoided in a manner similar to the manner in which skin overdose is avoided as discussed above.

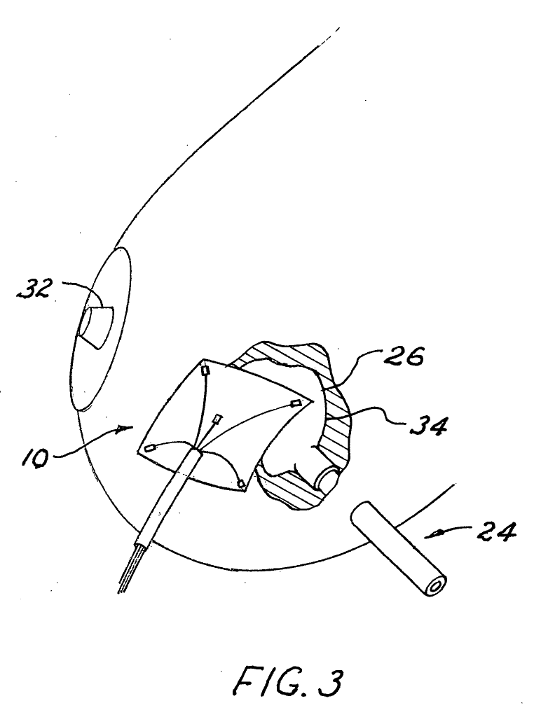

FIG. 3 is a perspective view in broken section of the anatomy and apparatus of FIG. 2. The nipple 32 is shown on the breast, and the balloon 34 of the applicator 24 is shown positioned within the resection cavity 26. The array 10 overlies the thinnest tissue portion adjacent to the resection cavity.

The output of either a skin array or percutaneous array can be used to indicate maximum absorbed dose at any one sensor of the array, or with computer modeling by the central processor, to deduce the location and magnitude of the absorbed dose at any position potentially at risk, from the collective sensor outputs of the array. This information can then be used to warn the therapist of a dangerous situation (an absorbed dose which exceeds or is likely to exceed a limit dose at the threshold for adverse cosmesis), can be used to control the therapy in real time (via the control line 21 in FIG. 1), or can be used to generate a permanent record of treatment actually delivered. Control can be by shutting off radiation if a limit dose is likely to be reached or exceeded, or by varying the level of radiation or the position of the source as the procedure continues, to prevent any point from exceeding the limit dose. An electronic source is useful for such control; it can be controlled as to current or voltage or both, or it can be shut off.

Different uses of the array output will be apparent to those of skill in the art in keeping the disclosure above. These uses are to be considered within the scope of the invention.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

1. A system for sensing radiation received at the skin surface during brachytherapy, comprising:
an array of radiation sensors carried on a flexible sheet of material adapted for placement on the skin of a patient adjacent to a brachytherapy location beneath the skin,
the array being large enough in area to cover any anticipated maximum skin dose point during a brachytherapy procedure,
a central controller separate from the radiation source with programming for control of the brachytherapy procedure,
communication means connecting the radiation sensors to the central controller,
whereby the sensors receive radiation from a radiation source in a brachytherapy procedure, and the dose received at each sensor can be communicated to the controller and monitored by the controller, which can calculate a point of maximum dose at the skin and can provide a warning if dose is projected to exceed a dose limit, or which can apply real time control to the brachytherapy radiation procedure, or which can generate a permanent record of treatment actually delivered.

2. The system of claim 1, wherein the flexible sheet comprises a polymeric film.

3. The system of claim 1, wherein the flexible sheet comprises a flexible circuit film.

4. The system of claim 1, wherein the communication means comprises wires secured to the flexible sheet, leading to the central controller.

5. The system of claim 1, wherein the system senses radiation dose at percutaneous locations as well as at the skin surface, and wherein the array further includes radiation sensors configured for placement percutaneously in a patient.

6. The system of claim 5, wherein the radiation sensors configured for placement percutaneously comprise sensors on the ends of needles.

7. The system of claim 1, wherein the flexible sheet has pressure-sensitive adhesive on a side of the sheet intended to contact a patient's skin, with a removable release covering on the adhesive for stripping prior to applying the sheet to a patient.

8. The system of claim 1, wherein the sensors are MOSFET sensors.

9. The system of claim 1, wherein the position of each sensor on the flexible sheet is partially radio-opaque, as an aid in imaging the location of the sensors relative to patient tissue.

10. A method for sensing radiation received at the skin surface during brachytherapy and for avoiding damage to the skin, comprising:
planning a brachytherapy procedure, including a site within a patient's body for placing a radiation source carried by an applicator, and estimating an approximate position on the skin where distance from the radiation source to the skin will be a minimum distance,
placing on the patient's skin, at a position so as to be directly over the approximate position of minimum distance, an array of radiation sensors carried on a flexible sheet of material,
providing a connection of the array of radiation sensors to a central controller separate from the radiation source and with programming for control of the brachytherapy procedure,
commencing brachytherapy with the applicator at the site,
as the brachytherapy proceeds, monitoring skin radiation dose received at each of the sensors and calculating dose received at many points along the sheet of material, including non-sensor positions calculated interpolation from dose readings taken at the sensors, and predicting any point of the skin which will reach or exceed a limit dose, and
if a point of the skin is predicted to receive a limit dose of radiation, doing one of the following:
(a) sending out a warning signal;
(b) controlling the brachytherapy by shutting off the radiation source to discontinue radiation;
(c) controlling the brachytherapy in real time by modifying the level of radiation emitted from the source or the position of the source.

11. The method of claim 10, wherein the flexible sheet of material with the array of sensors includes, on a side intended to contact the skin, a layer of pressure sensitive adhesive, with a removable release covering on the adhesive, and the method including removing the release covering prior to applying the flexible sheet to the patient.

12. The method of claim 10, the method further including sensing radiation received percutaneously during the brachytherapy, and further including placing percutaneous radiation sensors beneath the skin, carried on needles, to sense radiation in the vicinity of percutaneous tissues that could be at risk, and the monitoring step further including monitoring radiation dose received at the percutaneously-placed sensors and predicting any point of percutaneous tissue that will reach or exceed a limit dose.
